(19) United States
(12) Patent Application Publication
(10) Pub. No.: US 2022/0107232 A1
(43) Pub. Date: Apr. 7, 2022

(54) Flexplate Stress Measurement System

(71) Applicant: Methode Electronics Malta Ltd., Birkirkara (MT)

(72) Inventors: Johannes Gießibl, Amerang (DE); Ahmad Soufan, Beirut (LB); Sandro Khabiri, Munich (DE)

(21) Appl. No.: 17/494,995

(22) Filed: Oct. 6, 2021

(30) Foreign Application Priority Data
Oct. 7, 2020 (DE) 10 2020 126 235.3

(51) Int. Cl. G01L 3/14

(52) U.S. Cl. CPC G01L 3/1435

(57) ABSTRACT

A flexplate stress measurement system includes a flexplate being positioned between at least two components of a drive train of a vehicle. The flexplate is enclosed within the drive train and under operating conditions, is exposed to stress. At least one magnetic field sensing coil sensor is adapted and configured for measuring the stress acting on the flexplate under operating conditions within the drive train. The magnetic field sensing coil sensor being located on or in close proximity to the flexplate.

### RELATED APPLICATION DATA

The present application claims the benefit of German patent application DE 10 2020 126 235.3 filed on Oct. 7, 2020, the disclosure of which is incorporated by reference herein.

### BACKGROUND

The EP 3 550 165 A1 reveals a flexplate including a disc body having an inner radial portion, an outer radial portion and a contoured profile extending between the inner radial portion and the outer radial portion.

Disc based torque sensors are known in the state of the art. However, modern industries require disc-based torque sensors which would also maximize the available signal from the disc under stress to achieve a signal to noise levels by correctly placing the coils in relation to the plate.

### SUMMARY

This disclosure refers to a device and an associated method for a flexplate stress measurement system, comprising a flexplate, being positioned between at least two components of a drive train of a vehicle.

The flexplate is enclosed within the drive train under operating conditions. The flexplate is exposed to stress.

The flexplate stress measurement system further comprises at least one magnetic field sensing coil sensor for measuring the stress acting on the flexplate under operating conditions within the drive train.

The magnetic field sensing coil is in close proximity to the flexplate.

The flexplate stress measurement system measures the stress, preferably in form of torque, applied to a flexplate. The stress is measured by means of at least one magnetic field sensing coil.

The embodiments of the flexplate stress measurement system comprising the flexplate and the magnetic field sensing coil are described in detail below.

Examples and further advantages are illustrated and described below and in connection with the enclosed drawings.

### DESCRIPTION OF DRAWINGS

FIG. 1A is a schematic drawing showing an exemplary flexplate, a sensor and components that apply torque to the flexplate.

FIG. 1B is a chart correlating a torque applied to an exemplary flexplate and the resulting shear stress based on a radius and a thickness of the flexplate.

FIG. 2 shows a graphic representation of a distribution of stress on an exemplary flexplate when no torque is applied to the flexplate.

FIG. 3 shows a graphic representation of a distribution of stress on an exemplary flexplate when an external stress in form of a torque is applied to the flexplate.

FIG. 4 is a graph showing a sensitivity of a magnetic field sensing coil.

FIG. 5 is a graph showing a sensitivity of a magnetic field sensing coil.

FIG. 6 is a graph showing five sectors on which a pair of magnetic field sensing coils can be positioned on a flexplate.

FIG. 7 shows at least two parameters for a magnetization setup.

FIG. 8 shows commonly known sensor holders each carrying at least two magnetic field sensing coil sensors.

FIG. 9 is a graph showing a signal of a distance sensor and different torque signals.

FIG. 10 shows a compassing effect of the earth's magnetic field effecting a single coil of the magnetic field sensing coil.

FIG. 11 shows the optimum difference in sensitivity between inner coils and outer coils of the magnetic field sensing coils.

### Magnetic Field Sensing Coil Sensors

The flexplate stress measurement system 20 uses magnetic field sensing coil sensors 22 which are commonly known as magnetic field sensors.

A magnetic field sensor measures the magnetic flux density and field strength of a magnetic field and transmits them in analyzeable form preferably to an electronic device for signal processing. The magnetic flux density is measured in the unit T (Tesla).

Sensors may be classified according to their operation principle, for example to magnetic, optical, inductive and mechanical sensors.

Magnetic field sensors are, for example, used in the form of magnetic field sensing coils, hall probes or AMR/GMR.

Magnetic field sensors work in a contactless manner and thus without external mechanical operating force.

Preferably, the evaluation of the signal generated by the magnetic field on the respective sensor is carried out in a continuous, analogue or digital manner, namely either directly or by means of integrated or downstream electronics.

In the present case, each magnetic field sensor comprises at least one magnetic field sensor coil. The at least one coil preferably includes wire windings.

Thus, two magnetic field sensors include at least two magnetic field sensor coils. The magnetic field sensor coils are preferably arranged adjacent to one another. In their position in relation to one another, said coils measure a so-called inner magnetic band and an outer magnetic band as well as the magnetic field emitting from the magnetic bands.

In the following the magnetic field sensor is referred to as a magnetic field sensing coil sensor or a magnetic field sensing coil.

### Sensitivity of the Magnetic Field Sensing Coil Sensor

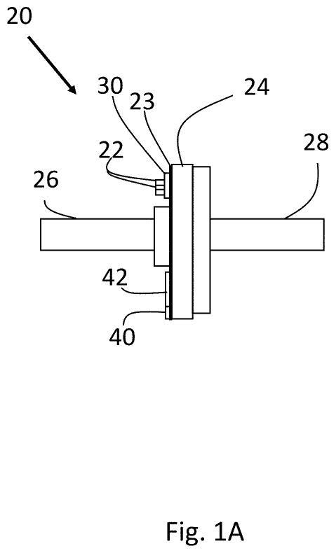

FIG. 1a provides a very general arrangement of the flexplate stress measurement system 20 which includes the magnetic field sensing coil sensor 22, having a variable sensitivity, and a flexplate 24.

According to one embodiment of the invention the sensitivity of the magnetic field sensing coil sensor 22 depends on the axial distance of the magnetic field sensing coil sensor relative to the flexplate 24.

According to another embodiment the sensitivity of the magnetic field sensing coil sensor depends on the thickness of the flexplate.

Also, the sensitivity of the magnetic field sensing coil sensor may depend on the radial distance of the magnetic field sensing coil sensor relative to a centre of the flexplate.

Also, the sensitivity of the magnetic field sensing coil sensor may depend on the distance of the at least two coils of the magnetic field sensing coil sensor relative to each other.

For compensating the influence of external magnetic stray fields and thus for compensating an influence of the magnetic field gradient generated due to the component geometry as well as for achieving the differing sensitivity, each single magnetic field sensing coil with its electronic circuit is an individual channel. Instead of the individual channel, magnetic field sensing coils of varying sensitivity may also be used.

The channel comprises the medium via which the signal transmission is carried out as well as the entire transmission path from a transmitter to a receiver.

For the purpose of compensating the influence of the magnetic field gradient on the two magnetic field sensing coil sensors, the channels of the respective magnetic field sensing coil sensors are controllable in such a manner that the influence of the magnetic field gradient on the magnetic field sensing coil sensor may be controlled through the sensitivity of the associated channel.

So-called magnetic field sensing coil sensors are high-sensitive magnetic field sensors. The magnetoelastic technology uses basic mechanical and magnetic properties of the material to measure various parameters. In this case, measurements are made of changes in the properties of magnetic fields which accompany a change in the mechanical properties, for example, the shear stress under the action of external forces on a mechanical component. The technology is applied by directly magnetizing a mechanical element, such as a flexplate, instead of attaching additional elements such as, for example, a ring or strain gauges. Highly sensitive magnetic field sensing coil sensors which are in the immediate vicinity of the magnetized element (flexplate) identify the change in the magnetic field properties which are proportional to the applied force. These changes are linear and reproducible within the elastic limits of the material. They are precise under normal application conditions.

### Flexplate

For reasons of simplification, it is assumed that the magnetic field sensing coil sensor 22, referred to above, is arranged on a flexplate 24.

It goes without saying, that the sensor, preferably the flexplate sensor, can be arranged on a flywheel and/or on a flexplate. The sensor however may also be installed on any disc shaped torque transferring component in any other application.

According to the invention a flexplate 24 is a metal disc which transmits an output torque of one component of a drive train 26, especially mounted in an engine of a vehicle, to an adjacent component of the drive train 28. The adjacent component 28 of the drive train receives the torque as an input torque.

The invention refers to a flexplate, which has a disc which flexes across its main access and bends from one side to the other.

Said flexplate takes up a motion from the torque converter as the rotation speed changes. The torque converter can also be a clutch of a manual transmission system.

Compared to so called fly wheels, known in the art, the flexplate is much thinner and of lighter weight. A fly wheel is a mechanical device specifically designed to efficiently store rotational energy (kinetic energy). This fact is due to a smooth coupling action of the torque converter and the diminution of the service of the employed clutch.

Known flexplates usually ensure a proper coupling of the drive train component (coupling; gearbox) to the engine of a motor driven vehicle. The magnetic field sensing coil sensor may be embedded between the flexplate and an engine housing.

Known flexplates may be equipped with teeth, cut along the circumferential edge of the flexplate.

The flexplate referred to by the invention effectively transmits the energy which is created by the engine.

The flexplate usually carries a variety of holes drilled into its surface.

Said holes are meant to facilitate mounting the flexplate to the crankshaft. The flexplate may be connected to a crankshaft of the engine of a vehicle. Whereby the crankshaft is a magnetic steel shaft.

Due to the magnetic properties and its mass of the crankshaft, the crankshaft deflects magnetic fields.

That magnetic field acts on the flexplate.

The flexplate is attached to a face side of the crankshaft.

In the area of the face side of the crankshaft, at least two magnetic field sensing coil sensors are arranged at a said distance therefrom.

It is assumed that the flexplate/fly wheel generates a magnetic field under stress.

Also, the flexplate is influenced by an external magnetic stray field.

On at least one end of the crankshaft the magnetic field is deflected.

Said magnetic field spreads out causing a magnetic gradient in a field magnitude, starting from the centre of the flexplate in a radial and outward bound direction.

Some of said holes take up torque converter settings as well as weight balancing means.

The flexplate, as it is commonly known, can be manufactured from steel.

The flexplate has a certain flexibility which enables the flexplate to adjust to slight misalignments between the engine and the transmission.

The flexibility of the flexplate prevents the flexplate from cracking or being otherwise damaged.

The flexplate shows its flexibility when a considerable force of a powerful engine causes the flexplate to spin at high speeds and/or when the torque converter comes into play, in order to change the gear in an automatic gear box.

### Thickness of the Flexplate

The flexplate usually has a thickness of at least 2 mm to 15 mm.

It is understood that the thickness of the flexplate can also adopt other values.

The thickness of the flexplate may influence the performance of the flexplate stress measurement system.

An increase of the thickness of the flexplate leads to a lower stress level as torque is applied to the flexplate.

Consequently, when a lower stress is applied to the flexplate, the flexplate stress measurement sensor emits a smaller sensor signal on the same level of torque.

However, a minimum thickness of the flexplate is required in order for the flexplate to carry a magnetic field properly.

The minimum thickness of the flexplate is also mandatory for a homogeneous stress distribution within the flexplate.

The thickness of the flexplate should have a value of at least 2 mm.

### Mounting Holes of the Flexplate

The flexplate provides at least two bore holes.

At least one screw is passed through each bore hole, thus fixing the flexplate to the adjacent component of the vehicle's drive train

In the following, a bore hole is referred to as a mounting hole. Said mounting holes can be arranged on the flexplate in even numbers or in odd numbers.

The mounting holes can be arranged annularly around a centre of the flexplate.

Radially to the centre of the flexplate at least two rings of mounting holes can be arranged next to each other on the flexplate.

When the flexplate is screwed to a component of the vehicles drive train, screws extend through the mounting holes into the adjacent component.

When the flexplate is screwed to the component of the drive train, a material stress acts on the flexplate in the area of mounting holes.

In another example, the flexplate has six mounting holes arranged on an inner circle of mounting holes and another six mounting holes positioned on an outer circle of mounting holes.

It goes without saying that the mounting holes can also be arranged on the flexplate in a different pattern.

The arrangement of six mounting holes both on an inner circle of mounting holes and on an outer circle of mounting holes lead to a repeating signal characteristic every sixty degrees.

According to the invention the number of stick boards 23 and/or the position of the magnetic field sensing coils on the flexplate can be evaluated by simulation.

It goes without saying that the number of stick boards 23 and the appropriate position of magnetic field sensing coils can also be evaluated manually or automatically.

### Torque

A torque act on the flexplate. This can be detected with a torque sensor (magnetic field sensing coil sensor).

In particular, in an automobile, a bicycle, any domestic appliance and in a machine tool technology and/or in aerospace technology, industrial target requirements are imposed to be able to detect both torque-related magnetic fields and also external magnetic fields with the aid of torque sensors.

As explained above, the invention refers to torque sensors as magnetic field sensing coil sensors.

The industry therefore requires the provision of an apparatus which is able to detect signals other than possibly torque-related signals or to detect signals with a different signal behaviour.

The required apparatus should be able to be delimit the influences disturbing the signal, possibly initiated by the torque.

The magnetic field sensing coil sensor may also be a magnetic field sensor and/or a magneto-elastic sensor.

The torque describes a rotational fact of a force acting on said flexplate.

### External Magnetic Fields

Such magnetic fields other than product-related ones and possibly torque-related signals, for example, may be caused by defects, interference effects and other influences of an in particular upstream or downstream product to be checked, on a magnetized region of the flexplate.

These additional influential parameters possibly originating from environmental influences such as for example power lines, rail lines, can produce external magnetic fields and have an influence on the detection of magnetic fields which, as explained above should be detected per se by the magnetic field sensing coil as a result of directly product-related (flexplate) quasi-targeted effects, possibly caused by torque.

These external magnetic fields can in particular be of relevance when magnetic field sensing coil sensors detect auxiliary influences which are not desired in the detection per se, for example, as a result of manufacturing tolerances with regard to which, when evaluating the detected results, it is not clear that these are results which not only reproduce the targeted effects possibly on the torque but which are influenced by such external events. The aim is therefore in particular to be able to distinguish between the sources of the magnetic fields which occur.

### Flexplate Stress Measurement System

### Plate Stress Distribution

FIG. 1B provides a chart showing a stress, preferably a shear stress, acting on the flexplate as a result of an applied torque for a given radius and thickness of the flexplate.

The magnitude of the stress (stress values) depends on the torque and on the radius of the flexplate.

By way of example, it is assumed that the flexplate has a thickness of at least 2 mm.

The flexplate stress measurement system proofs to be advantageous in that an identical level of magnetic field acts on the magnetic field sensing coils. The magnetic field is caused by the stress, preferably torque, acting on the flexplate.

It is assumed that the at least one magnetic field sensing coil arranged on the flexplate is positioned on the same level relative to a magnetic field reduction over a distance gradient point of view.

With a flexplate stress measurement system at least two magnetic field sensing coils are placed inline with said gradient. The magnetic field sensing coils, arranged with a higher distance to the centre of the flexplate, measure a lower magnetic field level.

### Mounting Hole Stress Distribution

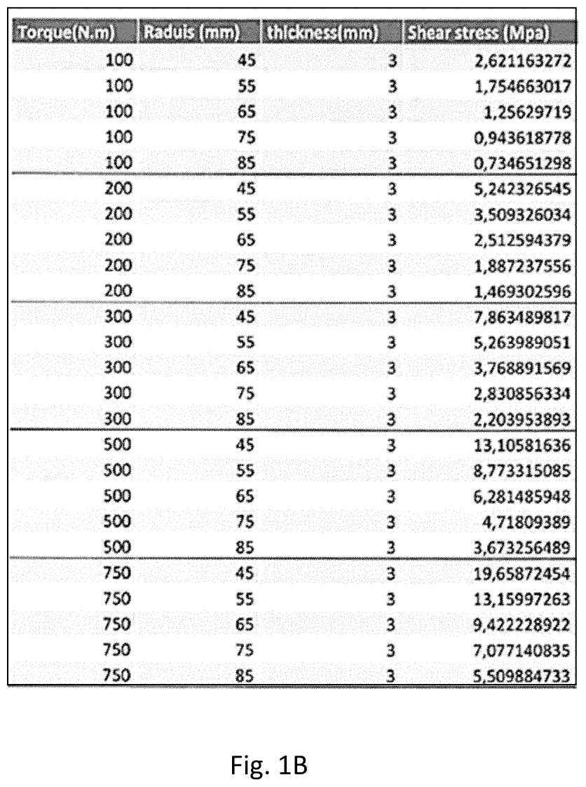

FIG. 2 shows a distribution of stress on the flexplate, assuming there is no stress in form of a torque applied present.

Even if there is no external stress (preferably torque) acting on the flexplate, FIG. 2 shows that stress acts on the flexplate at least in the areas of the mounting holes.

In the areas of the mounting holes the stress acting on the flexplate is initiated by the screws extending through the mounting holes and reaching into the flexplate. The screws link the flexplate to the adjacent component of the vehicles drive train.

In the FIG. 2 there is an inner annular circle and an outer annular circle of mounting holes.

Each circle of mounting holes comprises 8 mounting holes.

It goes without saying that the flexplate can also have a different number of mounting holes than shown in the FIG. 2.

Said mounting holes can also be arranged in a homogeneous or in an inhomogeneous manner on the flexplate.

In other words, it is assumed that the flexplate is fixed to least one component of a vehicle drive train by a number of screws, extending through the mounting holes which are drilled into the flexplate.

In the case shown in FIG. 2, assuming there is no external stress influencing the flexplate, stress is only acting on the flexplate in the areas of the mounting holes drilled into the flexplate, to receive the screws, fixing the flexplate to the adjacent component of the vehicle drive train.

According to the invention the stress acting on the flexplate, initiated by the screws, extending through the mounting holes influences the rotational signal uniformity (RSU).

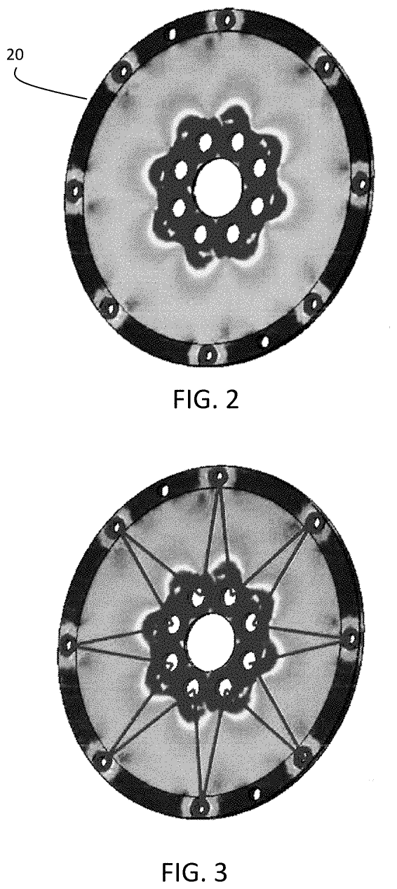

The FIG. 3 shows a flexplate similar to the flexplate of FIG. 2.

Contrary to the flexplate of FIG. 2, however, in the FIG. 3 external stress, preferably in form of torque, acts on the flexplate causing a different distribution of stress on the flexplate.

Both, the flexplate shown in the FIG. 2 and the flexplate shown in the FIG. 3 are firmly screwed to an adjacent component 28 of the drive train of the vehicle.

Contrary to the FIG. 2, in the case of the flexplate shown in the FIG. 3, additional stress in form of torque is applied to the flexplate.

The applied additional torque leads to an amended stress distribution pattern as shown in the FIG. 3.

In the example of the FIG. 3 the stress in form of torque is guided from at least one mounting hole to at least one other mounting hole arranged on the flexplate.

Further, in the case of the FIG. 3, the stress in form of torque is guided on the flexplate from at least one mounting hole of the outer circle of mounting holes to at least one mounting hole of the inner circle mounting holes of the flexplate.

Depending on the length of the distance between at least one mounting hole of the outer circle and at least one mounting hole of the inner circle of the mounting holes there is an inhomogeneous stress distribution pattern, as shown on the flexplate of FIG. 3.

Wherein in the FIG. 2 and the FIG. 3 there is a stress distribution pattern showing an increased amount of stress in the areas of mounting holes arranged on the flexplate, in the FIG. 3 an external stress acts on the flexplate.

This leads to an inhomogeneous stress distribution pattern.

In the example of the FIG. 3 the inhomogeneous stress distribution pattern is shown by the lines, connecting at least one mounting hole of the outer circle of mounting holes with at least one mounting hole of the inner circle of mounting holes arranged on the flexplate.

It goes without saying that the inhomogeneous stress distribution pattern as initiated by an external stress acting on the flexplate of FIG. 3 can also lead to other forms of stress distribution patterns. In other words, the external stress, in form of torque, acting on the flexplate shown in the FIG. 3 leads to lines and/or areas of external stress extending between at least one mounting hole of the outer circle of mounting holes and at least one mounting hole of the inner circle of mounting holes arranged on the flexplate.

By way of example the additional external stress (torque) acting on the flexplate, in FIG. 3 lead to a star-like stress distribution pattern acting on the flexplate.

The areas of the flexplate shown in the FIG. 3 arranged between the stress related star-like stress distribution pattern represent areas of a lower stress level.

### Field Scan and Radial Scan of the Flexplate

The so-called field scan shows a profile of the magnetic field arranged on the surface of the plate, preferably the flexplate. The split images are generated in 1 mm radial steps. They are created in a 0.1° resolution over a rotation of 360°.

As far as the radial scan is concerned, the magnetic field is scanned radially in 1 mm steps. The radial scan can be performed with or without the application of torque. Thus, the radial scan provides a sensitivity profile to determine any radial positions of the coils.

According to the invention the stress, preferably in form of torque, affecting the flexplate can be examined by a radial and/or a field scan

Relative to the radial scan, the field scan allows the analysis of a radial offset in a circumferential and/or in a radial manner.

The field scan also provides a full 360° scan for each radial position of the individual magnetic field sensing coil (increment 0.1°) .

The radial Scan referred to above, scans the signal of the flexplate stress measurement system on at least two different radial positions relative to the centre of the flexplate.

The radial Scan also scans the signal at least two different distances from the centre of the flexplate.

It also scans the signal at varied stress levels. Levels of varied stress represent level of varied torque.

The measurement on at least two different stress (torque) levels can also be performed with varying sensitivity levels regarding a radial position of the magnetic field sensing coil relative to the flexplate.

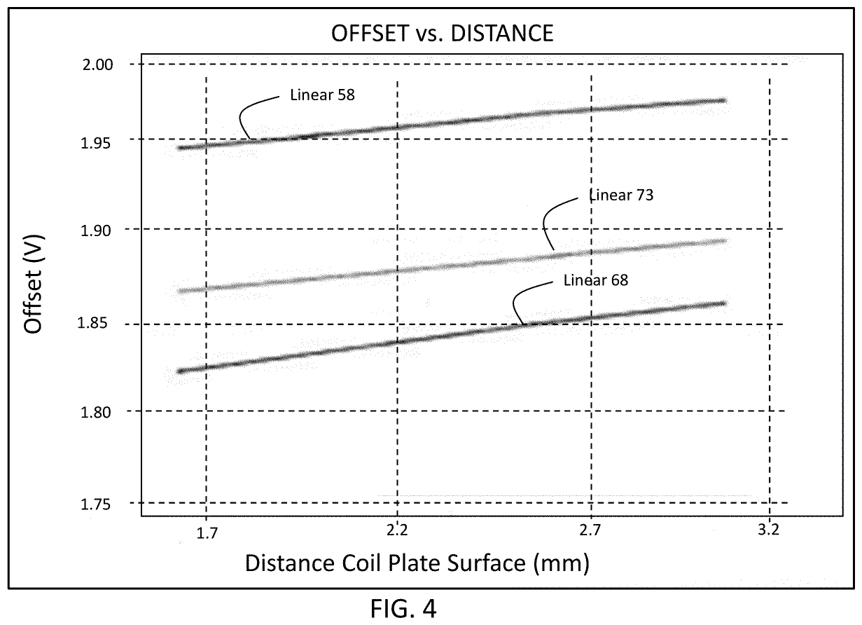

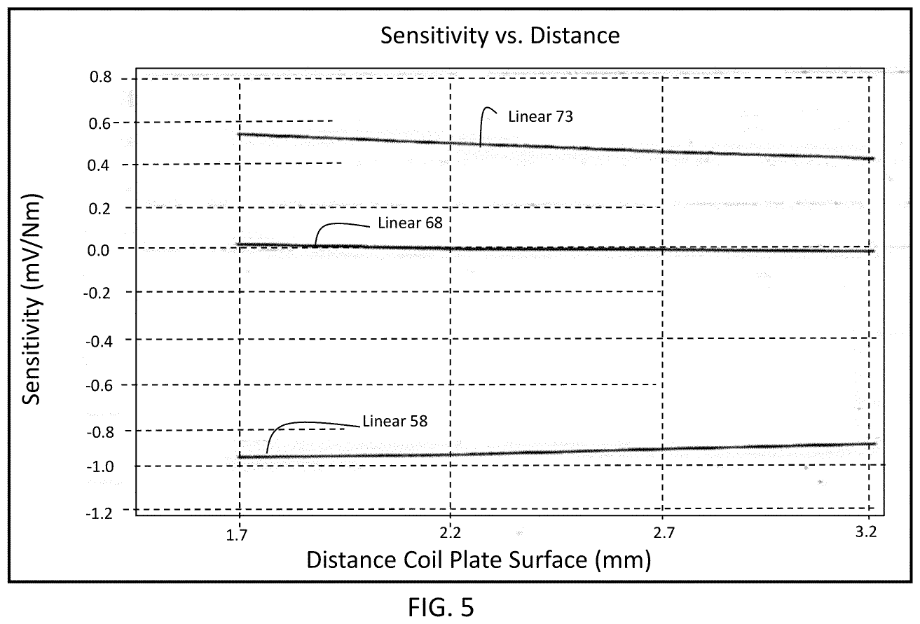

FIG. 4 and FIG. 5 represent the sensitivity of the magnetic field sensing coil. Here, the distance of the coil surface of the magnetic field sensing coil to the flexplate is examined.

Both FIG. 4 and FIG. 5 show three curves representing the signal of a magnetic field sensing coil at three different radial positions and with different distances to the plate surface

Assuming radial positions of magnetic field sensing coils of 58 mm, 68 mm and 73 mm to the centre of the flexplate, at least one signal emitted by the stick boards 23 (one pair of magnetic field sensing coils) can be calculated, having a coil distance of 10 mm and 15 mm to each other.

The graphs of FIG. 4 and FIG. 5 show a distance from coil to plate varying from 1.7 mm to 3.2 mm.

Starting from left to right, at 1.7 mm and at 3.2 mm, FIG. 4 shows a changing of the offset over the distance, whereas FIG. 5 represents the sensitivity of the magnetic field sensing coil over a given distance.

### Magnetic Field Sensing Coil Stick Board

According to the invention a pair of two magnetic field sensing coils is referred to as stick board. The Stick board is the combination of two coils arranged on a PCB with a distance of at least either 10 mm or 15 mm to each other.

The number of stick boards 23 arranged on the flexplate 24 depends on the diameter and/or the available radial space of the flexplate between the centre of the flexplate and the circumferential outer rim of the flexplate.

By way of example, two stick boards representing two pairs of magnetic field sensing coils are employed to compensate a magnetic sinus on the flexplate. It goes without saying that a higher number of stick boards can also be implemented.

A magnetic sinus of the flexplate can be measured by one stick RSU test.

According to the invention, preferably two pairs of magnetic field sensing coils (representing two stick boards) are arranged face to face to each other. In other words, said two pairs of magnetic field sensing coils can be arranged in a circle at a 0 degree and at a 180 degree position.

Implementing two pairs of magnetic field sensing coils the sinus effecting the flexplate can be completely compensated. This is done by averaging the signal over at least two measurement positions.

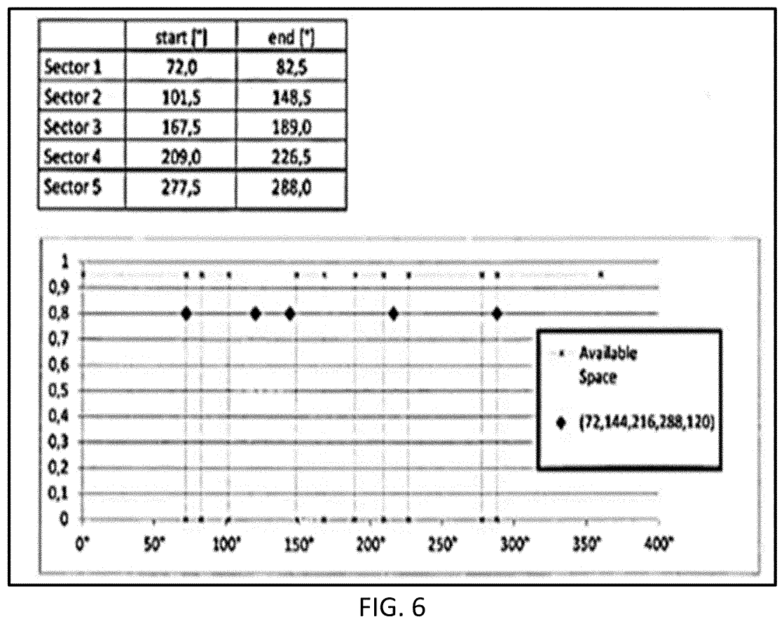

The data shown in the FIG. 6 gives numbers of five sectors in which stick boards (pair of magnetic field sensing coils) can be positioned on a flexplate.

In the example, in a first step a number of sectors is selected, in which magnetic field sensing coils are positioned in relation to the flexplate.

Said sectors are selected in a way to find the best positions to compensate known repeating effects.

In a second step, according to the convention a simulation is performed, leading to the positions in form of dots, shown in the graph of FIG. 6.

In the example of the FIG. 6 repeating patterns every 15, 30 and 60 degrees may be successfully compensated.

### Radial Coil Position

Magnetic field sensors are, for example, used in the form of magnetic field sensing coils, Hall probes. Magnetic field sensing coil as referred to by the invention are connected known magnetic field sensors.

In the present case, each magnetic field sensor (magnetic field sensing coil) comprises at least one magnetic field sensor coil. The at least one coil preferably includes wire windings.

Thus, two magnetic field sensing coil sensors include at least two magnetic field sensor coils. The magnetic field sensor coils are preferably arranged adjacent to one another. In their position in relation to one another, said coils measure a so-called inner band and an outer band as well as the magnetic field emitting from the bands.

In the following the magnetic field sensor is referred to as a magnetic field sensing coil sensor or magnetic field sensing coil.

According to the invention the radial position of the magnetic field sensing coil relative to the flexplate depends on the parameter of the magnetic field strength relative to the radial position of the magnetic field sensing coil to the flexplate.

The magnetic field strength of the flexplate depends on the magnets employed, the different type of magnet and the position of the magnet relative to the flexplate.

The sensor signal emitted by the flexplate stress measurement system depends on a strength of the magnetic bands used which themselves provide the best parameters to deliver the highest delta between said two magnetic bands.

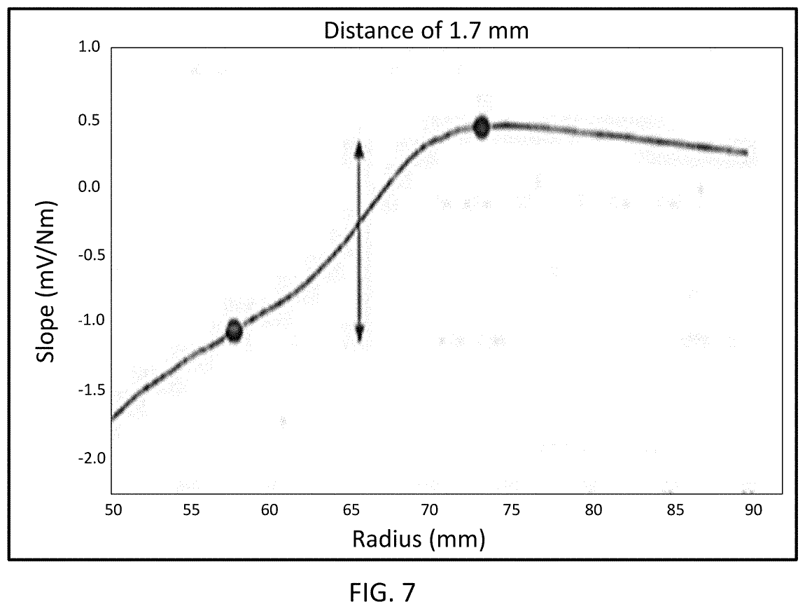

By way of example, FIG. 7 shows at least two parameters for a magnetization setup.

In the example of FIG. 7 an inner coil is positioned at a distance of 58 mm relative to the centre of the flexplate.

On the other hand, the highest signal level emitted by the flexplate stress measurement system is achieved when the outer coil is arranged at a position of 73 mm relative to the centre of the flexplate.

Thus, the signal emitted by the flexplate stress measurement system not only depends on the individual placement of the coils relative to the centre of the flexplate.

It also depends on the distance at which both coils are arranged on the flexplate relative to each other.

A higher distance between said two coils provides a higher delta in the magnetic fields strength, thus leading to a higher signal output of the flexplate stress measurement. Thus, the higher the distance between the coils, the worse the external magnetic field rejection.

A smaller distance between said two coils leads to a smaller delta in the magnetic fields strength. This again provides a lower output signal of the flexplate stress measurement system but a better external magnetic field rejection

### Temperature Sensor

Commonly known temperature sensors are usually electrical or electronic elements.

The temperature sensor usually provides an electrical signal as a measure of temperature.

According to the invention the flexplate stress measurement system comprises a temperature sensor 40.

Said temperature sensor allows a compensation of temperature behaviours of the flexplate stress measurement system. The temperature sensor also allows the compensation of temperature behaviour within the flexplate.

It goes without saying that the temperature sensor can be manufactured as a sealed or as an unsealed temperature sensor.

Experiments have shown that results delivered by a sealed temperature sensor are widely identical to the results of an unsealed temperature sensor. Thus, most temperatures sensors 40 embedded into the flexplate sensor arrangement are sealed temperature sensors.

Sealing the temperature sensors leads to an improved protection of the sensor against the environment.

### Minimum Packing Space of Magnetic Field Sensing Coils Within the Flexplate

The minimum packing space of at least two magnetic field sensing coils within the flexplate is defined by the size of the individual magnetic field sensing coil.

Common magnetic field sensing coil sensors have a height of preferably 2 mm.

In a radial direction the flexplate has a minimum size to be able to carry at least two magnetic field sensing coil sensors.

Said magnetic field sensing coil sensors are arranged in relation to the flexplate in radial direction.

Having a coil distance of at least 15 mm the arrangement of two magnetic field sensing coils leads to a minimum radial space of the flexplate of about 23 mm.

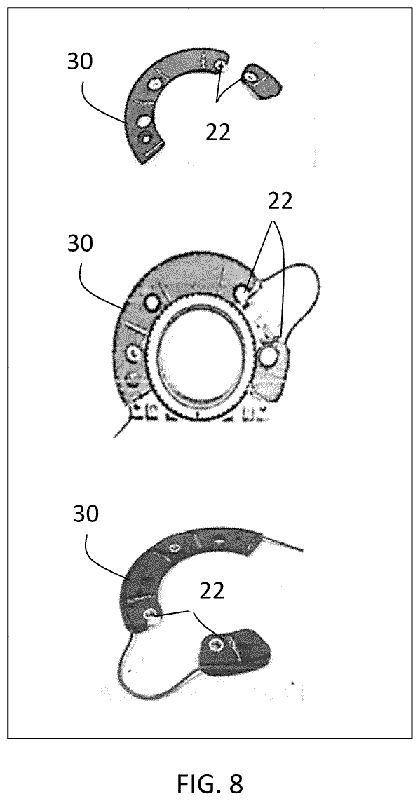

In FIG. 8 commonly known sensor holders 30 are shown, each carrying at least two magnetic field sensing coil sensors 22.

### Distance Sensor

According to the invention a distance sensor, also called displacement sensor, measures the distance between two distinct objects. In other words, the distance sensor measures the distance between an object and a reference point.

The distance sensor 42 is also designed to measure length changes.

In the context of the invention the distance between the flexplate sensor and the flexplate of the drive train to which the flexplate is firmly screwed can vary during the operation of the drive train.

The flexplate bends and/or moves while stress and/or load and/or torque is applied to the flexplate.

By way of example, when the stress load (torque) applied to the drive train is high, preferably the component of the drive train adjacent to the flexplate presses against the flexplate.

Correspondingly, the flexplate is pressed in the direction of the magnetic field sensing coil.

Thus, the distance of the magnetic field sensing coil to the flexplate will be reduced.

Therefore, a smaller distance between the flexplate and the magnetic field sensing coil is achieved.

A smaller distance between the flexplate and the magnetic field sensing coil commonly leads to a higher measurement signal.

It goes without saying that the movement of the flexplate is not based on the applied torque alone.

The relevant movement of the flexplate also depends on the torque and/or it depends on the rotational speed of the flexplate.

Further, it depends on whether the converter (as the adjacent component to the flexplate) is closed or not.

The distance sensor thus compensates the influence of the movement of the flexplate relative to the adjacent components.

Knowing the precise distance between the magnetic field sensing coil and the flexplate in a no stress condition (as shown in FIG. 3), in real time, the increased or decreased signal may be corrected.

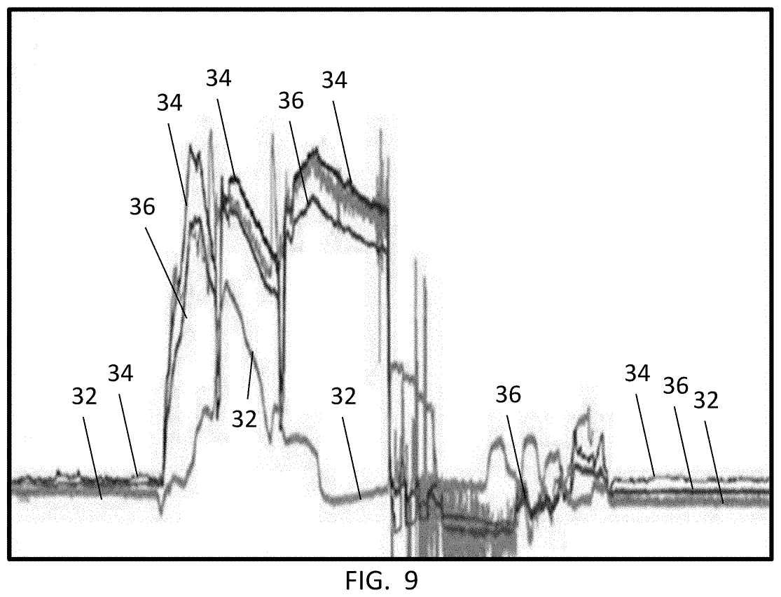

In FIG. 9, the graph indicated by reference character 32 represents the signal of the distance sensor, wherein the graph indicated by reference characters 34,36 represent different torque signals.

The signals 34,36 represent the torque transmitted from the flexplate.

The graphs shown in the FIG. 9 clarify that there is almost no movement between the flexplate and the adjacent components of the drive train in the centre of the flexplate. Approaching the outer rim of the flexplate coming from the centre of the flexplate, there is an increased movement between the flexplate and the adjacent components of the drive train.

### Influence of an External Magnetic Stray Field on the Flexplate

In the case where the flexplate emits a magnetic field, for example under application of torque, the magnetic field sensing coil must be capable of detecting a magnetic field.

The detected magnetic field may be influenced in different ways. There may be a configuration of at least two metal bodies (flexplate and crankshaft). Also, the magnetic field sensing coils may be arranged non-symmetrically in relation to the flexplate.

Should the magnetic field sensing coil however detect more than one magnetic field of different magnetic densities, the greater the difference in the density of the magnetic fields are, the higher the magnetic field gradient gets.

The magnetic field sensing coil arranged on the flexplate can be disturbed by an external magnetic field. For example, such an external magnetic field may be the (homogeneous) earth's magnetic field.

It is also possible that another magnetic field acts, for example temporarily, on the flexplate. Such a situation may occur when the flexplate is arranged in a proximity to further electric components. Alternatively, it may occur, when the flexplate is installed in a vehicle moving, for example, near an electric cable of a tram, crossing tram tracks or the like. All such external magnetic fields act on the flexplate described above. These are so-called magnetic stray fields.

These magnetic stray fields may influence or overlap the magnetic field position described above, which is generated by a force acting on the flexplate.

When the magnetic field sensing coil is disturbed by the earth magnetic field the magnitude of the magnetic measurement signal (preferably torque) received by the magnetic field sensing coil is about a factor of 10 higher than the earth magnetic field.

According to the invention the magnetic field sensing coil compensates the earth magnetic field influence by using at least two differential signals for a common mode rejection.

The invention refers to the common mode rejection as summing the output signals of at least two magnetic field sensing coils, wherein all common mode external magnetic fields are cancelled.

As described above, such common mode external magnetic fields can be nearfields of any kind.

The common mode rejection, known in the state of the art, may be achieved by generating at least two opposing magnetically coded field bands arranged on the flexplate.

The magnetically coded field bands are measured by at least one coil each.

The differential interconnection of the at least two coils lead to the common mode rejection.

In the theoretical case that the crankshaft of the vehicle deflects the homogenous earth magnetic field, the compensation of the earth magnetic field will even be improved when both coils of at least one stick board share an equal sensitivity. In other words, in a normal driving condition, a vehicle will be set under an earth magnetic field influence as if the vehicle was rotated around an axis which is perpendicular to the earth surface.

The coils referred to above comprised in the flexplate, each on an inner magnetic band and on an outer magnetic band are arranged on different radial positions.

Eventually the earth magnetic field has a compassing effect on the magnetic field sensing coil, disturbing the output signal of the magnetic field sensing coil when the magnetic field sensing coil is moved in the earth magnetic field.

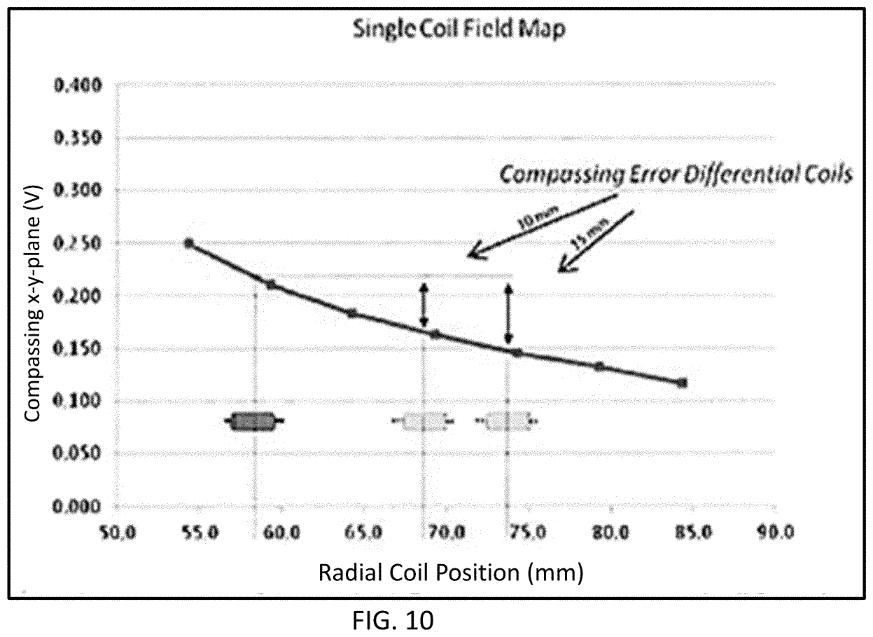

FIG. 10 represents the compassing effect of the earth magnetic field effecting a single coil of the magnetic field sensing coil. Here, the coil of the magnetic field sensing coil was not compensated when the flexplate, preferably mounted to the crankshaft, rotates 360° on an axis perpendicular to the road on which the vehicle is moving, at different radial positions.

This is to show that the magnitude of the magnetic field decreases with an increasing distance of the coil of the magnetic field sensing coil relative to the component adjacent to the flexplate.

According to the invention, to reduce the effect of compassing, the amplitude of differential coils of the magnetic field sensing coils, compassing at different radial positions, must be harmonized.

For harmonization purposes shielding can be done by redirecting magnetic fields.

To achieve single coil gain adjustment the compassing amplitude can be harmonized by either reducing the gain of the coil, being closer to the adjacent component. Alternatively, it can be achieved by increasing the gain of the coil which is further away from the adjacent component.

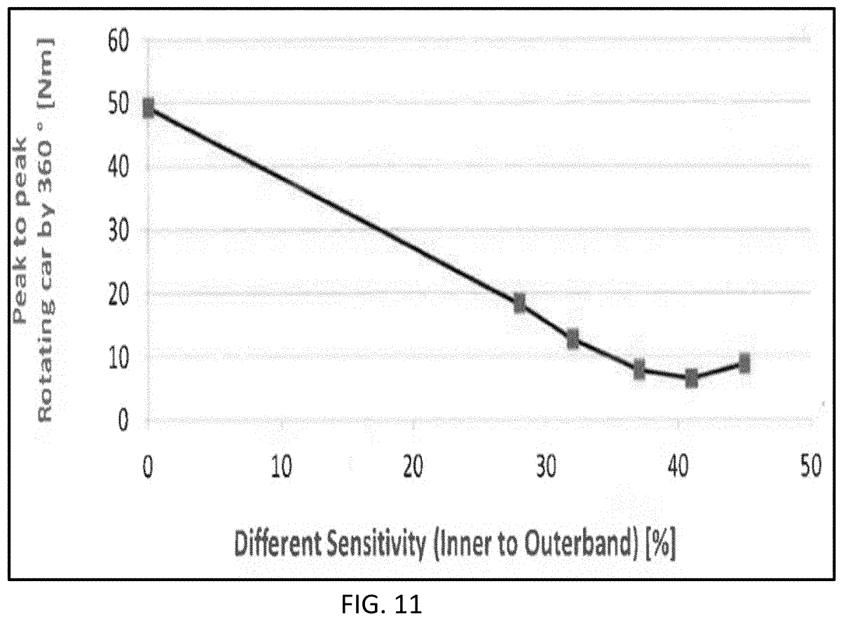

Results of tests performed by using the invention are shown in the graph of FIG. 11 (below), identifying the optimum difference in sensitivity between inner coils and outer coils of the magnetic field sensing coils.

In the specific examples shown in the FIG. 11 the lowest sensitivity of the earth magnetic field achievable was performed by applying a difference of around for 42%.

### Shielding the Flexplate Stress Measurement System

The effect of shielding the flexplate stress measurement system can be achieved by shielding a back-biased magnetic speed sensor.

A crankshaft sensor may be installed close to an un-shielded magnetic field sensing coil torque sensor of the flexplate. Given the case that the crankshaft sensor is not shielded, it may lead to a permanent magnetisation of the flexplate.

It can also be performed by re-directing the earth magnetic field to have a homogeneous effect on both sensing coils of the magnetic field sensing coil.

### Method

Method in which, with the aid of a system for determining the stress of a flexplate, the stress acting on the flexplate is determined.

The flexplate, positioned between at least two components of a drive train of a vehicle under operating conditions, being exposed to stress, wherein

at least one magnetic field sensing coil sensor for measuring the stress acting on the flexplate under operating conditions within the drive train, being located in close proximity to the flexplate.

What is claimed is:

1. A flexplate stress measurement system comprising:
a flexplate adapted and configured to be positioned between and operatively connected with at least two components of a drive train of a vehicle, wherein the flexplate is adapted and configured to be exposed to stress when the drive train is operated, and
at least one magnetic field sensing coil sensor for measuring the stress acting on the flexplate when the flexplate is exposed to stress when the drive train is operated,
wherein the magnetic field sensing coil sensor is arranged between the flexplate and at least one of the at least two components of the drive train.

2. A flexplate stress measurement system according to claim 1, wherein the magnetic field sensing coil sensor is placed in-line with a magnetic gradient caused by a magnetic field.

3. A flexplate stress measurement system according to claim 1, wherein the magnetic field sensing coil sensor comprises at least two coils, wherein at least two coils form a stick board.

4. A flexplate stress measurement system according to claim 1, wherein the magnetic field sensing coil sensor has a variable sensitivity.

5. A flexplate stress measurement system according to claim 4, wherein the sensitivity of the magnetic field sensing coil sensor depends on the axial distance of the magnetic field sensing coil sensor relative to the flexplate.

6. A flexplate stress measurement system according to claim 4, wherein the sensitivity of the magnetic field sensing coil sensor depends on the radial distance of the magnetic field sensing coil sensor relative to a center of the flexplate.

7. A flexplate stress measurement system according to claim 4, wherein the sensitivity of the magnetic field sensing coil sensor depends on the thickness of the flexplate.

8. A flexplate stress measurement system according to claim 4, wherein the sensitivity of the magnetic field sensing coil sensor depends on the distance of the at least two coils of the magnetic field sensing coil sensor relative to each other.

9. A flexplate stress measurement system according to claim 1, wherein the flexplate has a thickness influencing a performance of the magnetic field sensing coil sensor.

10. A flexplate stress measurement system according to claim 1, wherein the flexplate is exposed to stress in the area of at least one mounting hole.

11. A flexplate stress measurement system according to claim 1, wherein the flexplate has an inhomogeneous or a homogeneous stress distribution pattern.

12. A flexplate stress measurement system according to claim 5, wherein the stress is guided from at least one mounting hole to at least one other mounting hole arranged on the flexplate.

13. A flexplate stress measurement system according to claim 1, wherein the flexplate has a field scan profile of the at least one magnetic field.

14. A flexplate stress measurement system according to claim 1, wherein the flexplate has a minimum packing space of at least two magnetic field sensing coils.

15. A flexplate stress measurement system according to claim 1, comprising at least one temperature sensor.

16. A flexplate stress measurement system, according to claim 1, comprising at least one distance sensor.

17. A method of determining stress acting on the flexplate wherein the flexplate is positioned between at least two components of a drive train of a vehicle, the method comprising:
providing at least one magnetic field sensing coil sensor in close proximity to the flexplate or on the flexplate; and
with the at least one magnetic field sensor, measuring the stress acting on the flexplate when the flex plate is subjected to stress by at least one of the at least two components of the drive train of the vehicle.
